(19) United States
(12) Patent Application Publication
(10) Pub. No.: US 2018/0357634 A1
(43) Pub. Date: Dec. 13, 2018

(54) METHOD OF PROVIDING MOBILE VOUCHER SERVICE, AND TERMINAL DEVICE, SERVER DEVICE AND SYSTEM THEREFOR

(71) Applicant: PLATFOS CO., LTD., Seoul (KR)

(72) Inventor: Young Joon Shin, Yongin-si, Gyeonggi-do (KR)

(21) Appl. No.: 15/757,824

(22) PCT Filed: Sep. 5, 2016
(86) PCT No.: PCT/KR2016/009927

§ 371 Date: Mar. 6, 2018

(30) Foreign Application Priority Data
Sep. 7, 2015 (KR) 10-2015-0125997
Sep. 7, 2015 (KR) 10-2015-0125998
Nov. 16, 2015 (KR) 10-2015-0160099

(51) Int. Cl. G06Q 20/34; G06Q 20/36; G06Q 40/04; H04W 4/12

(52) U.S. Cl. CPC G06Q 20/342; G06Q 20/36; H04W 4/12; G06Q 40/04; G06Q 20/351

(57) ABSTRACT

The present invention relates to a method for providing a mobile voucher service, and a terminal apparatus, a server apparatus and a system therefor. The method comprises the steps of: acquiring location information of another user to be presented with a mobile voucher; configuring a mobile voucher list including one or more mobile vouchers available at affiliate shops adjacent to another user's location on the basis of the acquired location information of the another user; acquiring exchange rate information between first and second countries when the first country where the user of a terminal device is located and the second country where the another user is located are different; converting a price calculated by the currency of the second country into the currency of the first country for the mobile voucher included in the mobile voucher list on the basis of the acquired exchange rate information; and processing the configured mobile voucher list to be transmitted to the terminal device together with information on the price of the mobile voucher converted into the currency of the first country.

### TECHNICAL FIELD

The present invention relates to a method for providing mobile gift certificate service.

### BACKGROUND ART

A gift certificate is a kind of ticket including value of a predetermined sum, and mainly used by a business entity as a means for promotion and inducement of purchase on a merchandise thereof. And it may be used for a present means between users or between user and business entity.

Specifically, mobile gift certificate, exchange ticket, discount coupon, sum coupon, and the like (hereinafter, ‘mobile gift certificate’) are actively distributed thanks to development of communications technology and to enlarged spread of mobile terminal device such as smart phone or the like recently. The mobile gift certificate like above may be purchased as a gift of an individual to other person or may be transmitted to a customer through an event of a business entity for promotion or the like.

However, conventional mobile gift certificate service has some inconvenience that a plurality of steps of user inputs should be passed to present the mobile gift certificate.

And, the usage is stayed in a local service where such a mobile gift certificate is still transmitted and used between users in only one country.

### DISCLOSURE

### Technical Problem

The object of the present invention is to provide a method for providing mobile gift certificate service, and a terminal device, a server device and a system for the same which may improve user's convenience and at the same time may be adapted with an optimized targeting technique.

And, another object of the present invention is to provide a global method for providing mobile gift certificate service, and a terminal device, a server device and a system for the same which allowing transmission and usage between countries.

### Technical Solution

A method for providing mobile gift certificate service according to an embodiment of the present invention to solve the problem above may provide mobile gift certificate service at a server which can communicate with a terminal device, and comprises acquiring other user's anniversary information and location information who being related to a user; transmitting an anniversary notification information to the user's terminal device to have an anniversary notification message be displayed on the terminal device including GUI (Graphic User Interface) for presenting the mobile gift certificate to the other user using the acquired other user's anniversary information; and transmitting a mobile gift certificate information to the terminal device in case that the GUI included in the anniversary notification message is selected to have a mobile gift certificate list selected based on the other user's location information be displayed on the terminal device.

A method for providing mobile gift certificate service according to another embodiment of the present invention comprises acquiring other user's location information to whom a mobile gift certificate being presented; organizing a mobile gift certificate list including one or more mobile gift certificates usable at affiliate members adjacent to the other user's location based on the acquired other user's location information; acquiring an exchange rate information between a first country and a second country in case that the first country where the user of the terminal device being located and the second country where the other user being located are different each other; converting a price calculated in a currency of the second country to that of the first country with respect to the mobile gift certificate included in the mobile gift certificate list based on the acquired exchange rate information; and processing for the organized mobile gift certificate list to be transmitted to the terminal device together with information on the price of the mobile gift certificate converted in the currency of the first country.

A server device according to an embodiment of the present invention may perform a method for providing mobile gift certificate service described above.

On the other hand, the method for providing mobile gift certificate service may be implemented as a recording medium readable by a computer in which a program being recorded for implementing the same on the computer.

And, a system for providing mobile gift certificate service according to an embodiment of the present invention comprises a terminal device receiving selection of other user to whom the mobile gift certificate being presented from a user; and a mobile gift certificate management server for organizing a mobile gift certificate list including one or more mobile gift certificates usable at affiliate members adjacent to the other user's location based on the other user's location information, for acquiring an exchange rate information between a first country and a second country in case that the first country where the user of the terminal device being located and the second country where the other user being located are different each other, and for converting to provide a price calculated in a currency of the second country to that of the first country with respect to the mobile gift certificate included in the mobile gift certificate list based on the acquired exchange rate information.

### Advantageous Effects

According to an embodiment of the present invention, the anniversary notification message with a GUI (Graphic User Interface) such as a button for presenting the mobile gift certificate included may be transmitted in linkage to applications such as contact, schedule management and social network service and the like, and the mobile gift certificate list may be selected based on the other user's location, kind of anniversary, relationship, age, and the like to whom the mobile gift certificate may be presented, by which convenience of the user of the mobile gift certificate can be improved and at the same time optimized mobile gift certificate service can be provided.

And, the location based mobile gift certificate service like above may be implemented as applicable between countries, by which transmission and usage of the mobile gift certificate between users located in different countries each other can be performed conveniently.

### DESCRIPTION OF DRAWINGS

FIG. 1 is a block diagram showing an organization of a system for providing mobile gift certificate service according to an embodiment of the present invention.

FIG. 2 is a flow chart showing an embodiment with respect to a method for providing mobile gift certificate service performed on an application server.

FIG. 3 is a flow chart showing an embodiment with respect to a method for providing mobile gift certificate service performed on a terminal device.

FIG. 4 is a flow chart showing an embodiment with respect to a method for providing mobile gift certificate service performed at a mobile gift certificate management server.

FIG. 5 is a timing chart showing an embodiment with respect to a method for providing mobile gift certificate service at the system for providing mobile gift certificate service.

FIG. 6 to FIG. 13 are drawings showing embodiment with respect to screens provided at user's terminal device for mobile gift certificate service.

FIG. 14 is a timing chart showing another embodiment with respect to a method for providing mobile gift certificate service at the system for providing mobile gift certificate service.

FIG. 15 is a drawing showing another embodiment with respect to a screen provided at user's terminal device for mobile gift certificate service.

### BEST MODE

Hereinafter, a method for providing mobile gift certificate service, a server device and a system for the same according to an embodiment of the present invention are described in detail with reference to the attached drawings.

The present invention may be applied with a variety of change, and may have a variety of embodiments, in which a specific embodiment is illustrated in drawings and is described in detail. This is not to confine the present invention within a specific implement form, but all the changes, equivalents and substitutes can be understood to be included to the idea and technical range of the present invention.

The terminologies used in the present application are used only for description of specific embodiment, not of intention to confine the present invention. The expression of singularity can include the expression of plurality unless of which the meaning is explicitly differently set in context.

In the present invention, the term of ‘include’ or ‘have’ or the like is to designate the existence of feature, number, step, operation, constitution factor, part or combination thereof written in the specification, and the existence or possibility of addition of one or more other features, numbers, steps, operations, constitution factors, parts or combinations thereof is understood to be not excluded in advance.

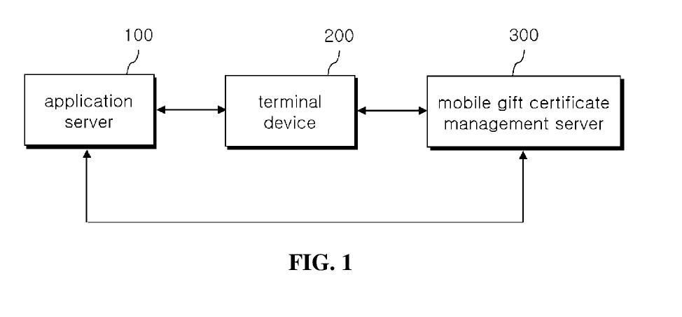

FIG. 1 shows a block diagram showing an organization of a system for providing mobile gift certificate service according to an embodiment of the present invention, wherein the system for providing mobile gift certificate service may be organized to include application server 100, terminal device 200 and mobile gift certificate management server 300.

Referring to FIG. 1, the application server 100 may link to a certain application installed in the terminal device 200 to perform a role to operate the corresponding application at the terminal device 200.

For the above, the application server 100 may be connected to the terminal device 200 through communication network such as internet or the like to send and receive information for implementation and operation of the application.

For example, the applications operated by the application server 100 may be ones for provide with contact, schedule management and social network service (SNS) and the like.

The terminal device 200 may be cellphone, smart phone, desktop computer, laptop computer, terminal device for digital broadcasting, PDA (Personal Digital Assistants), PMP (Portable Multimedia Player), navigation or the like, by which the present invention is not limited, but may be a variety of other devices capable of user input and information display and the like.

On the other hand, the mobile gift certificate management server 300 may perform functions to have the user of the terminal device 200 be able to present the mobile gift certificate to the other user, and for example, may perform functions of communicating with the terminal device 200 and application server 100 to receive the user's request to transmit the mobile gift certificate list and purchase result, of transmitting the mobile gift certificate to the terminal device (not shown) of other user who is being presented with the mobile gift certificate, of processing payment on the mobile gift certificate, of processing usage approval on the mobile gift certificate, and of adjusting money of sales and fees.

In the database (DB) of the mobile gift certificate management server 300, information on plurality of mobile gift certificate which can be presented, information of pay result, information on users, information of adjustment of money of sales and fees, information of result of usage of the mobile gift certificate and the like are stored.

The mobile gift certificate means a gift certificate of data type stored in a memory used in a payment way of storing in the terminal device such as cellphone or the like and showing the gift certificate stored in the terminal device at the time of purchase of merchandise at a shop, not a variety of conventional paper or plastic card type, and for example, may be exchange ticket, discount coupon, sum coupon or the like.

The application server 100 may transmit the anniversary notification information to the terminal device 200, in case that the other user's anniversary information related to the user is corresponding to the current date and time, to have the anniversary notification message including a GUI (Graphic User Interface) for presenting the mobile gift certificate to the other user be displayed on the user's terminal device 200.

The other user widely means any person who has relationship with the user of the terminal device 200, and specifically a person whose information is stored in the database of the application server 100 in relation to the information on the corresponding user, and for example, may be another user registered as friend of the corresponding user at SNS service or a acquaintance.

On the other hand, the anniversary may include a variety of schedules to celebrate or to applaud such as birthday or wedding anniversary or the like.

The terminal device 200 may display the anniversary notification message including a GUI for presenting the mobile gift certificate to the other user who has the anniversary using the anniversary notification information received from the application server 100.

And, the mobile gift certificate management server 300 may transmit the mobile gift certificate information which the user can select to the application server 100 or terminal device 200 in case that the GUI included in the anniversary notification message is selected by the user at the terminal device 200.

The mobile gift certificate management server 300 may select a portion of the mobile gift certificate from the purchasable mobile gift certificate based on the other user's location to organize as a mobile gift certificate list which the user can select.

For example, the mobile gift certificate list provided from the mobile gift certificate management server 300 to be displayed on the terminal device 200 may include the mobile gift certificates usable at the affiliate members adjacent to the other user's location.

For the above, the application server 100 or terminal device 200 may transmit the other user's location information to the mobile gift certificate management server 300, and the mobile gift certificate management server 300 may store location information of affiliate member with respect to each of the purchasable mobile gift certificates.

On the other hand, the other user's location information may include information with respect to the other user's address stored in the application server 100 or terminal device 200 or the other user's current location (more specifically, current location of the terminal device possessed by the other user) verified through the application server 100.

The mobile gift certificate management server 300 may organize the mobile gift certificate list to be provided to the terminal device 200 based on not only the other user's location information but also a variety of information on the corresponding other user such as kind of anniversary, relationship between the user and the other user or the other user's age or sex or the like.

For the above, the application server 100 or terminal device 200 may transmit information on the other user's anniversary information, the relationship between the user and the other user, or the other user's age or sex or the like to the mobile gift certificate management server 300.

When the mobile gift certificate list is displayed on the terminal device 200, the user may select the mobile gift certificate and pay which the user may want to present to the other user from the mobile gift certificate list displayed on the terminal device 200.

In this case, the mobile gift certificate management server 300 may transmit the selected mobile gift certificate to the designated other user's terminal device (not shown).

According to an embodiment of the present invention, the mobile gift certificate management server 300 may select a portion of mobile gift certificates among the purchasable mobile gift certificates based on the other user's location to organize as a mobile gift certificate list which the user can select.

For example, the mobile gift certificate list provided from the mobile gift certificate management server 300 to be displayed on the terminal device 200 may include usable mobile gift certificates of the affiliate members adjacent to the other user's location.

For the above, the application server 100 or terminal device 200 may transmit the other user's location information to the mobile gift certificate management server 300, and the mobile gift certificate management server 300 may store the location information of the affiliate member with respect to each of the purchasable mobile gift certificates.

On the other hand, the other user's location information may include the other user's address stored in the application server 100 or terminal device 200 or information with respect to the other user's current location (more specifically, current location of the terminal device possessed by the other user) verified through the application server 100.

According to another embodiment of the present invention, the mobile gift certificate management server 300 may organize the mobile gift certificate list to be provided to the terminal device 200 based on not only the other user's location information, but also a variety of information with respect to the corresponding other user such as type of anniversary, the relationship between the user and the other user, or the other user's age or sex or the like.

And, in case that the user of the terminal device 200 who presents the mobile gift certificate and the other user who is presented with the mobile gift certificate are located in different countries each other, the mobile gift certificate management server 300 may convert the tax or the like according to the exchange rate and region to a price including exchange rate or tax between the user's and the other user's countries, to process it be displayed on the terminal device 200.

For example, considering difference of nationality between the user and the other user, the mobile gift certificate management server 300 may perform functions of translating automatically related information into a language of a certain country, of transmitting the mobile gift certificate to the other user's terminal device (not shown), of processing payment on the mobile gift certificate, of processing usage approval on the mobile gift certificate, and of adjusting money of sales and fees and the like.

For the above, in the database (DB) of the mobile gift certificate management server 300, not only information on a plurality of mobile gift certificates which can be presented, information of result of payment, and information on users, but also information on exchange rate between countries and tax of corresponding region, information of adjusting money of sales and fees, and information of result of usage of the mobile gift certificate and the like are stored.

According to an embodiment of the present invention as described above, GUI (Graphic User Interface) such as a button for presenting the mobile gift certificate may be included in the anniversary notification message and may be transferred with linkage to application such as schedule management and social network service and the like, and the mobile gift certificate list may be selected based on the other user's location, kind of anniversary, relationship, age, and so forth, by which the user's convenience of mobile gift certificate service can be improved and at the same time an optimized targeting based mobile gift certificate service can be provided.

And, the location based mobile gift certificate service as described above is implemented as applicable between countries, by which transmission and usage of the mobile gift certificate between users located at different countries each other can be performed conveniently.

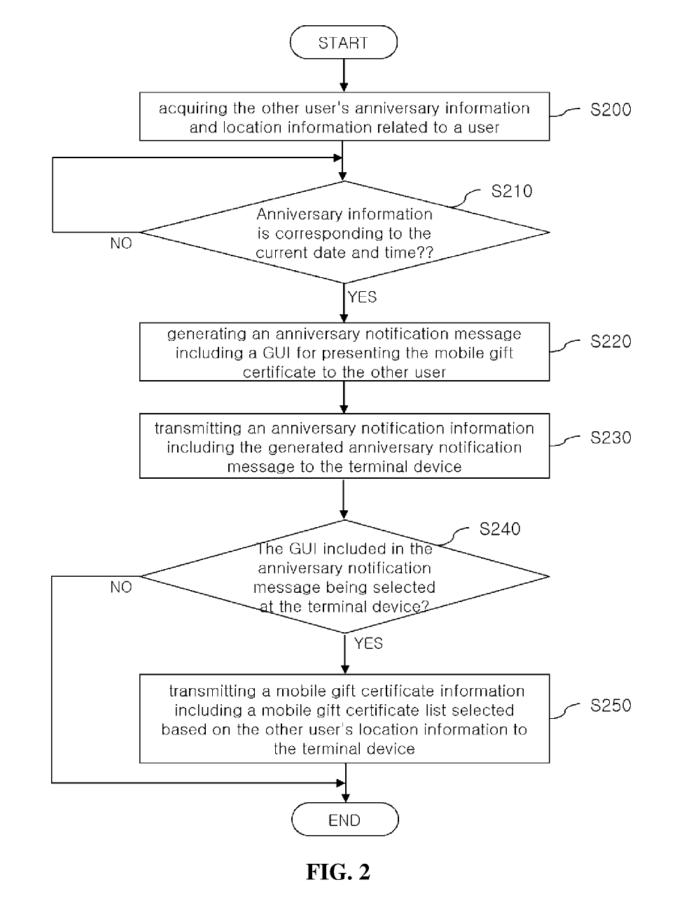

FIG. 2 shows the method for providing mobile gift certificate service according to an embodiment of the present invention as a flow chart, which shows the method for providing mobile gift certificate service of the application server 100 shown in FIG. 1.

Referring to FIG. 2, the application server 100 may acquire the other user's anniversary information and location information related to the user of the terminal device 200 (S200) and may compare the other user's anniversary information and current date and time to verify whether corresponding to each other (S210).

The anniversary information may be acquired with linkage to at least one application of contact, schedule management and social network service (SNS) which the user of the other user may use.

On the other hand, in case that the anniversary date included in the other user's anniversary information is within a predetermined range in reference to current date, the anniversary information may be judged to be corresponding to current date and time.

For example, in case that the application server 100 is a server for providing an SNS service application such as Face book or the like, the anniversary information such as the other user's birthday or wedding anniversary who is registered as friend with the user of the terminal device 200 may be stored in the database of the application server 100.

On the other hand, in case that the application server 100 is a server for providing a contact application, the other user's the anniversary information such as birthday or wedding anniversary or the like may be stored together with the telephone number in the contact of the user of the terminal device 200, or the anniversary information such as birthday or wedding anniversary or the like of oneself which the other user inputted may be stored in the database of the application server 100 to be shared with each other through the contact application.

And, in case that the application server 100 is a server for providing a schedule management application, the other user's anniversary information such as birthday or wedding anniversary or the like may be inputted in the user's schedule of the terminal device 200, or other user's anniversary information such as birthday or wedding anniversary or the like which the other user inputted may be stored in the database of the application server 100 to be shared each other through the schedule management application.

According to an embodiment of the present invention, the other user's address may be stored in the database of the application server 100 as described above, and in case that collection of location information by the corresponding application is allowed at the other user's terminal device, the application server 100 may acquire the other user's current location information through the GPS or the like.

In case that other user's anniversary information corresponds to current date and time, the application server 100 may generate the anniversary notification message including the GUI for presenting the mobile gift certificate to the other user (S220) and may transmit the anniversary notification information including the generated anniversary notification message to the terminal device 200 (S230).

For example, in case that today is the other user's anniversary or the other user's anniversary is within several days from today according to the other user's anniversary information acquired at S200 above, the application server 100 may generate the anniversary notification message to notify the other user's anniversary to transmit to the user's terminal device 200.

The GUI included in the anniversary notification message may be a button for switching to the screen where the mobile gift certificate to be presented to the other user can be selected, and the user may press the button displayed together with the other user's anniversary notification message on the screen of the terminal device 200 to present the mobile gift certificate to the other user.

When the GUI included in the anniversary notification message may be selected at the terminal device 200 (S240), the mobile gift certificate information including the mobile gift certificate list selected based on the other user's location information may be transmitted to the terminal device 200.

The mobile gift certificate information transmitted to the terminal device 200 at S250 above may include one or more mobile gift certificates selected by the mobile gift certificate management server 300 based on the other user's location information transmitted from application server 100 or terminal device 200.

And, the mobile gift certificate information transmitted to the terminal device 200 at S250 above may be selected by the mobile gift certificate management server 300 based on information on at least on of kind of anniversary, relationship between the user and the other user, and the other user's age.

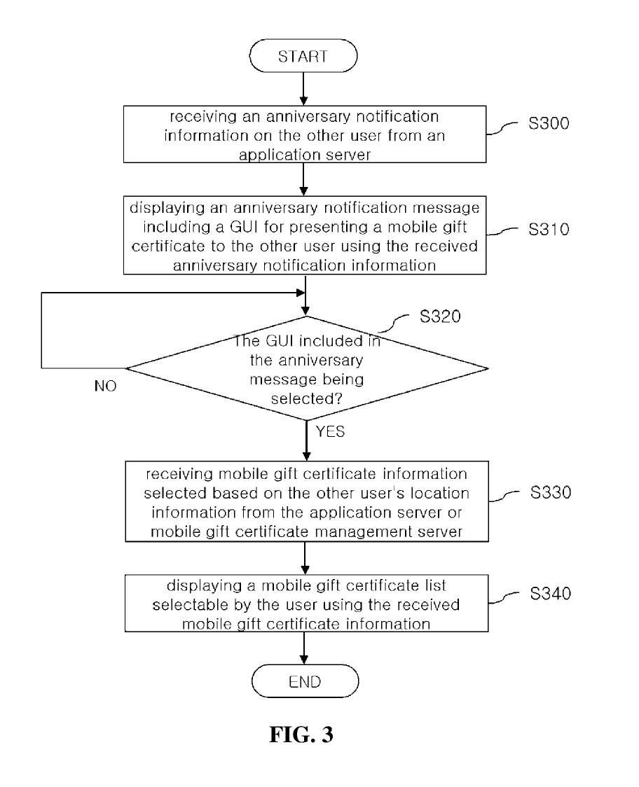

FIG. 3 shows the method for providing mobile gift certificate service according to an embodiment of the present invention as a flow chart, which shows the method for providing mobile gift certificate service of the terminal device 200 shown in FIG. 1.

Referring to FIG. 3, the terminal device 200 may receive the anniversary notification information on the other user from the application server 100 (S300) and may display the anniversary notification message including the GUI for presenting the mobile gift certificate to the other user using the received anniversary notification information (S310).

After then, when the GUI included in the anniversary message is selected by the user of the terminal device 200 (S320), the terminal device 200 may receive the mobile gift certificate information selected based on the other user's location information from the application server 100 or mobile gift certificate management server 300 (S330).

For example, in case that the button for presenting the mobile gift certificate included in the anniversary notification message is selected by the user of the terminal device 200, the application server 100 may receive information on the mobile gift certificates selected based on the other user's location information from the mobile gift certificate management server 300, and may transmit the mobile gift certificate information received from the mobile gift certificate management server 300 to the terminal device 200 to have the mobile gift certificate list be displayed on the terminal device 200.

According to another embodiment of the present invention, the GUI included in the anniversary notification message may include information for connecting to the mobile gift certificate management server 300 (for example, address information on the mobile gift certificate management server 300, URL), and when the user press the button for presenting the mobile gift certificate, the terminal device 200 may connect to the mobile gift certificate management server 300 to receive the mobile gift certificate information.

According to further another embodiment of the present invention, the GUI included in the anniversary notification message may include an identification information on the mobile gift certificate application which links to the mobile gift certificate management server 300, and when the user press the button for presenting the mobile gift certificate, the terminal device 200 may implement the corresponding mobile gift certificate application to receive the mobile gift certificate information from the mobile gift certificate management server 300.

On the other hand, in case that the mobile gift certificate application is not installed on the terminal device 200, the terminal device 200 may connect to a server for download the corresponding application.

After then, the terminal device 200 may display the mobile gift certificate list selectable by the user on the screen using the received mobile gift certificate information.

The user may select the mobile gift certificate to present to the other user from the mobile gift certificate list displayed on the screen of the terminal device 200.

The information on the mobile gift certificate selected by the user may be transmitted to the mobile gift certificate management server 300 through the application server 100 or may be transmitted directly from the terminal device 200 to the mobile gift certificate management server 300.

On the other hand, the method by which the mobile gift certificate management server 300 processes present request for the mobile gift certificate received from the terminal device 200 may be the same as that of conventional mobile gift certificate service, of which the detailed explanation may be omitted.

According to an embodiment of the present invention, the mobile gift certificate information provided to the terminal device 200 at S250 of FIG. 2 and at S330 of FIG. 3 may be one organized as the transmission and usage of the mobile gift certificate to be possible between users located in different countries each other.

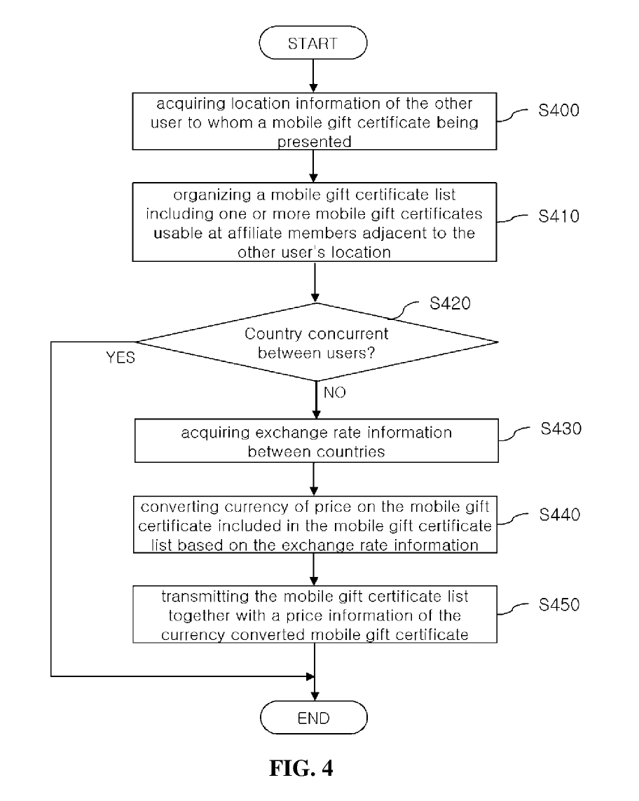

Hereinafter, in reference to FIG. 4, an embodiment for method for providing mobile gift certificate service of the mobile gift certificate management server 300 between users of different countries each other will be described in more detail. On the other hand, the description on the same thing of the method for providing mobile gift certificate service shown in FIG. 4 as that described in reference to FIG. 1 to FIG. 3 will be omitted below.

Referring to FIG. 4, the mobile gift certificate management server 300 may acquire the other user's location information who may receive present of the mobile gift certificate from the application server 100 or terminal device 200 (S400).

The mobile gift certificate management server 300 may organize the mobile gift certificate list including one or more mobile gift certificates usable at the affiliate members adjacent to the other user's location based on the other user's location information acquired at S400 (S410).

On the other hand, the mobile gift certificate management server 300 may verify whether countries between users are concurrent (S420), and in case that the first country where the user of the terminal device 200 is located and the second country where the other user is located are different to each other, the exchange rate information between the first country and second country may be acquired (S430).

After then, the mobile gift certificate management server 300 may convert the currency of price on each of the mobile gift certificates included in the mobile gift certificate list organized at S410 based on the exchange rate information acquired at S430.

For example, the mobile gift certificate management server 300 may convert the price calculated in a currency of the second country where the other user is located to the currency of the first country where the user of the terminal device 200 is located according to the exchange rate with respect to the corresponding mobile gift certificate.

The mobile gift certificate management server 300 may process so that the mobile gift certificate list is transmitted to the terminal device 200 together with price information of each of the mobile gift certificate converted in the currency of the first country (S450).

As described above, the mobile gift certificate list including price information of the mobile gift certificate converted in currency may be transmitted directly from the mobile gift certificate management server 300 to the terminal device 200 or may be delivered to the terminal device 200 through the application server 100.

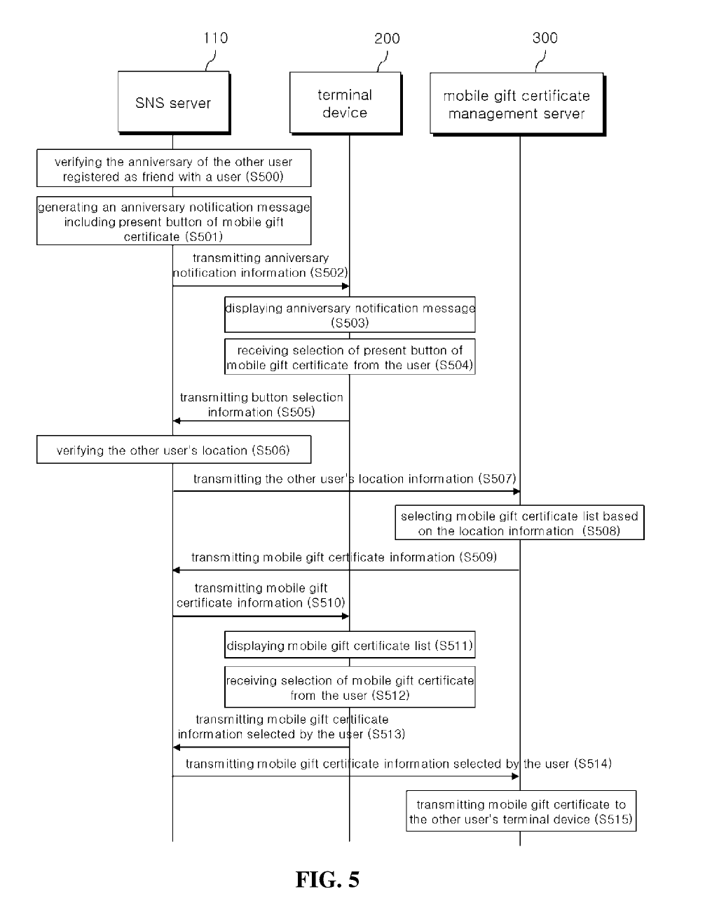

Hereinafter, referring to FIG. 5 to FIG. 13, embodiments on the method for providing mobile gift certificate service according to the invention will be described in detail.

FIG. 5 shows an embodiment of the method for providing mobile gift certificate service at the system for providing mobile gift certificate service as a timing diagram, in which the method for providing mobile gift certificate service according to an embodiment of the present invention is shown with an example of the case that the application server 100 is an SNS server providing an SNS application. On the other hand, description on the same thing in the method shown in FIG. 5 as that described in reference to FIG. 1 to FIG. 4 will be omitted.

Referring to FIG. 5, the SNS server 110 may verify the other user's anniversary registered as friend to the user of the terminal device 200 (S500), may generate the anniversary notification message including the present button of mobile gift certificate (S501), and may transmit the anniversary notification information including the generated anniversary notification message to the terminal device 200 (S502).

The terminal device 200 may display the anniversary notification message notifying the other user's anniversary on the screen using the anniversary notification information transmitted from the SNS server 110 (S503).

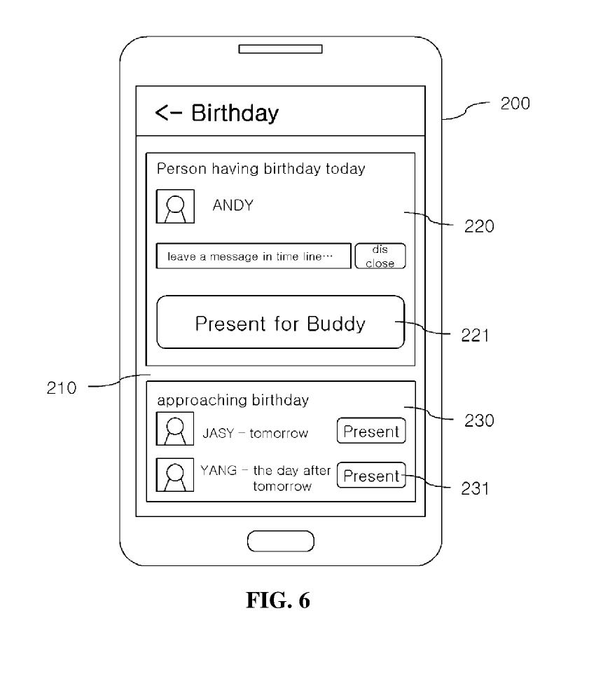

FIG. 6 to FIG. 9 show embodiments on the method of displaying the anniversary notification message including the present button of mobile gift certificate in the screen of the terminal device 200.

Referring to FIG. 6, when an SNS application operated in linkage to the SNS server 110 is implemented at the terminal device 200, an anniversary notification message 220 notifying that birthday of the other user (ANDY) registered as friend to the user of the terminal device 200 is today may be displayed on the screen 210 of the terminal device 200.

The anniversary notification message 220 displayed on the screen 210 of the terminal device 200 may include a button 221 of “Present for Buddy” to have the mobile gift certificate be presented to the corresponding other user(ANDY).

And, the anniversary notification message 230 notifying that birthday of other user (JASY, YANG) registered as friend is approaching may be displayed additionally on the screen 210 of the terminal device 200, and the “Present” button 221 to allow presenting the mobile gift certificate to each of the corresponding other users (JASY, YANG) may be included also in the anniversary notification message 230 notifying approaching birthdays.

In the above, an embodiment of the present invention has been described as the present button of mobile gift certificate being included in the anniversary notification messages 220 and 230, by which the present inventio may not be limited to such, but a variety of methods in which present button of mobile gift certificate is displayed on one screen together with anniversary notification message 220 and 230 may be possible.

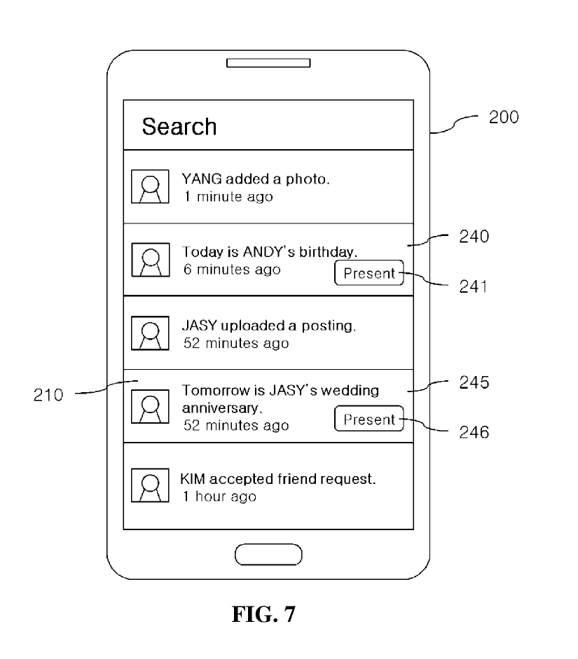

Referring to FIG. 7, the anniversary notification messages 240 and 245 of other users (ANDY, JASY) registered as friend may be displayed in a status window of the SNS application implemented at the terminal device 200, and the “Present” button 221 which enables presenting the mobile gift certificate to the corresponding other user may be included also in the anniversary notification messages 240 and 245 displayed in the status window of the SNS application.

On the other hand, the other user's anniversary notification who is registered as friend in the SNS application may be provided through the notification bar displayed on upper end of the terminal device 200.

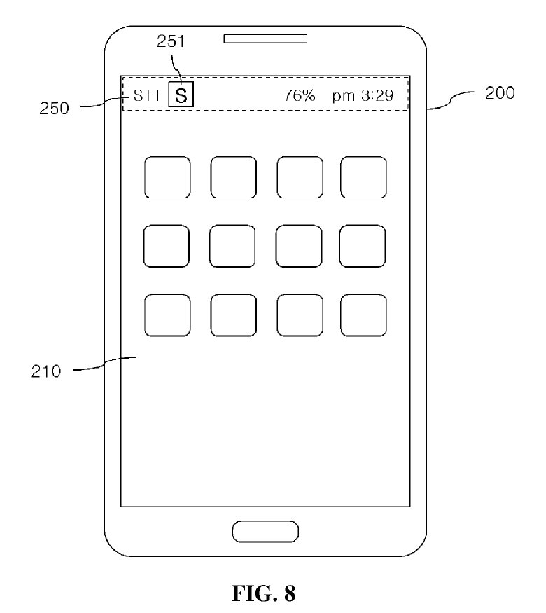

Referring to FIG. 8, an icon of the corresponding SNS application may be displayed on the notification bar at the upper end of the screen 210 to notify that the birthday of the other user (ANDY) registered as friend is today.

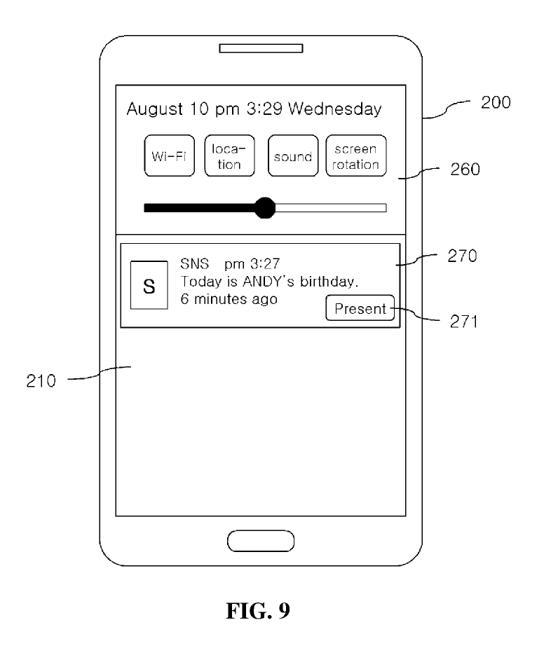

When the user pull down the notification bar at the upper end of the screen 210, as shown in FIG. 9, the anniversary notification message 270 notifying that the birthday of the other user (ANDY) registered as friend is today may be displayed on the screen 210 together with the status display window 260 of the terminal device, and the “Present” button 271 enabling presenting the mobile gift certificate to the corresponding the other user (ANDY) may be included in the anniversary notification message 270.

As described above, when the present button of mobile gift certificate displayed together with the anniversary notification message is selected by the user of the terminal device 200 (S504), the terminal device 200 may transmit a button selection information showing that the user selected the present button of mobile gift certificate to the SNS server 110 (S505).

The SNS server 110 may verify the other user's location (S506) and may transmit the verified other user's location information to the mobile gift certificate management server 300 to request the mobile gift certificate information corresponding to the location (S507).

In response to the above request, the mobile gift certificate management server 300 may select the list of the mobile gift certificates based on the received other user's location information (S508) and may transmit the mobile gift certificate information including the generated mobile gift certificate list to the SNS server 110 (S509).

For example, the SNS server 110 may transmit the other user's address information stored in the database to the mobile gift certificate management server 300, and the mobile gift certificate management server 300 may search the mobile gift certificates usable at the affiliate member adjacent to the other user's address who is to be presented using the address information received from the SNS server 110 to organize the mobile gift certificate list.

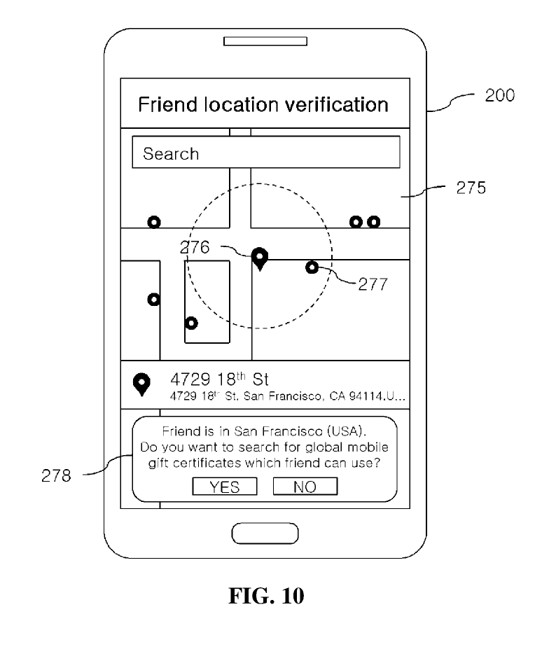

Referring to FIG. 10, in case that the user may verify the anniversary notification message transmitted from the application server 100 and may select the buttons 221, 231, 241, 246, 271 for presenting the mobile gift certificate as shown in FIG. 6 to FIG. 9, a friend location verification screen 275 displaying the other user's location may be displayed on the terminal device 200.

On the friend location verification screen 275, the address or current location 276 of friend may be displayed, and with the same as the center, the locations 277 of the affiliate members usable the mobile gift certificate located within a predetermined distance may be displayed.

The user may select any one of the locations of the affiliate members displayed on the screen of the terminal device 200 to have the list of the mobile gift certificates usable at the corresponding affiliate member be displayed, may increase the predetermined distance to enlarge the range of the affiliate members to be included in the mobile gift certificate list, or may select other affiliate member except the selectable affiliate members located in the predetermined distance to have the list of the mobile gift certificate usable at the corresponding affiliate member be displayed.

According to an embodiment of the present invention, in case that the user of the terminal device 200 to present the mobile gift certificate and the other user to be presented with the mobile gift certificate may be located at different countries each other, the mobile gift certificate usable abroad where the other user is located may be searched at the mobile gift certificate management server 300 to be provided to the screen 200 of the terminal device 200.

For example, as shown in FIG. 10, in case that the user of the terminal device 200 is located in ‘Korea’ and the address or current location of friend to be presented with the mobile gift certificate is ‘San Francisco’ in ‘USA’, a popup window 278 for selecting whether to search the mobile gift certificate usable at the overseas region of location of friend may be displayed on the screen of the terminal device 200.

According to another embodiment of the present invention, in organizing the mobile gift certificate list, the mobile gift certificate management server 300 may consider additionally the corresponding other user's anniversary information (birthday, wedding anniversary or the like), relationship between the user and the other user (family, friends, lovers or degree of intimacy or the like), the other user's age or sex, or the like from the application server 100.

The SNS server 110 may transmit the mobile gift certificate information received from the mobile gift certificate management server 300 to the terminal device 200 (S510).

The terminal device 200 may display the mobile gift certificate list selectable by the user on the screen using the mobile gift certificate information received from the application server 100 (S511), and the mobile gift certificate to be presented to the other user may be selected by the user from the mobile gift certificate list displayed above.

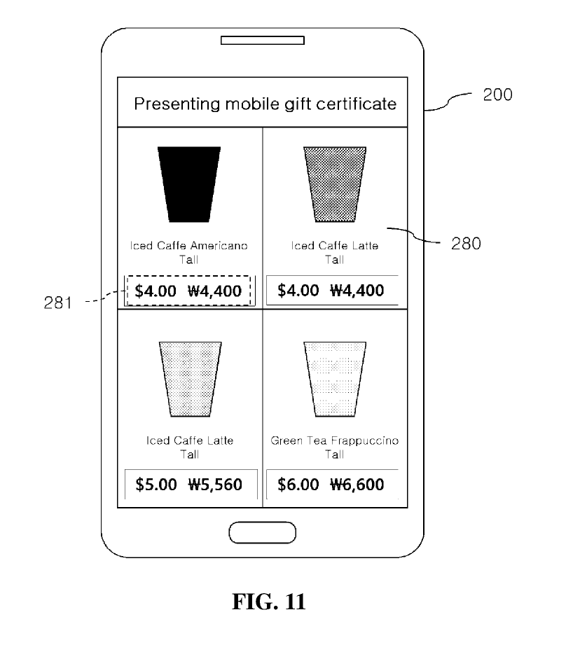

Referring to FIG. 11, the user may select the mobile gift certificate 280 to be presented to the other user from the mobile gift certificate list displayed on the screen 210 of the terminal device 200.

On the other hand, for each of the mobile gift certificate included in the mobile gift certificate list, a price converted to the exchange rate of the user's country according to the reference exchange rate of current time point (or, current date) may be displayed on the lower end region 281 of the merchandise image together with the price in a currency of the overseas site of the corresponding merchandise.

For example, in case that the current exchange rate between ‘USD (US dollar)’ and ‘KRW (Korean WON)’ verified by the mobile gift certificate management server 300 is ‘1,100 KRW per 1 USD’, the price of the mobile gift certificate exchangeable to the merchandise of ‘Iced Caffe Americano Tall’ at a ‘Starbucks’ shop located within 5 km of radius with a certain region in San Francisco where the other user is locating as the center may be displayed as ‘\4,400’ in KRW converted according to the exchange rate together with ‘$4.00’ in USD.

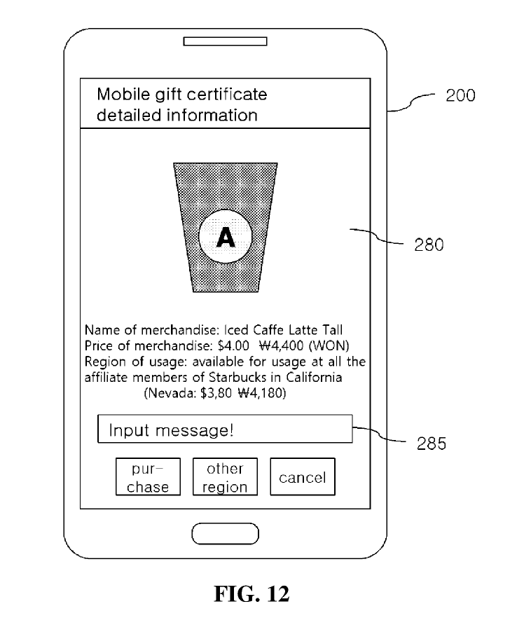

In case that the user may select any one 280 from the mobile gift certificate list displayed on the screen of the terminal device 200, as shown in FIG. 12, a detailed information on the corresponding mobile gift certificate 280 may be displayed on the screen.

For example, name of the merchandise, price of the merchandise (in USD and KRW), currency of payment, and information on region to be used with respect to the corresponding mobile gift certificate 280 may be displayed on the screen of the terminal device 200.

More specifically, in case that the other user being presented with the mobile gift certificate is located in the boundary region between different states each other in ‘USA’, two or more different prices each other on the same merchandise generated by the difference of pricing policy or tax or the like may be included in the price information.

As shown in FIG. 12, a mobile gift certificate may be purchased by which the corresponding product can be exchanged with the mobile gift certificate of the price displayed above at all the affiliate members of ‘Starbucks’ located in California state where the other user is located, while the corresponding product can be exchanged at lower price of ‘$3.80’ at Nevada state adjacent to California state.

On the other hand, in case that price generated by the difference of price policy or tax or the like on the same merchandise is different by ‘state’ such as ‘USA’ or ‘Canada’ or the like, the mobile gift certificate management server 300 may group the plurality of affiliate members whose price and tax on the same merchandise is the same as one usable group of the mobile gift certificate based on the merchandise price and tax by region in the corresponding country.

For example, in case of merchandise with the same price at both of California state where the other user is located and Oregon state adjacent to it, the corresponding mobile gift certificate may be grouped as usable at the affiliate members located two states.

For the above, the mobile gift certificate management server 300 may verify frequently the merchandise information, shop information, tax information and price change information (POS change matter) and so on for each of the overseas affiliate members to update on the database (DB) with linkage to a local agency API installed in the server of the overseas affiliate member or the like.

In cast that the user may select ‘Purchase’ on the screen shown in FIG. 12, the mobile gift certificate management server 300 may process to have the mobile gift certificate selected by the user be transmitted to the other user's terminal device.

On the other hand, the mobile gift certificate may be transmitted to the other user's terminal device using the social network service selected by the user of the terminal device 200 among the plurality of social network service.

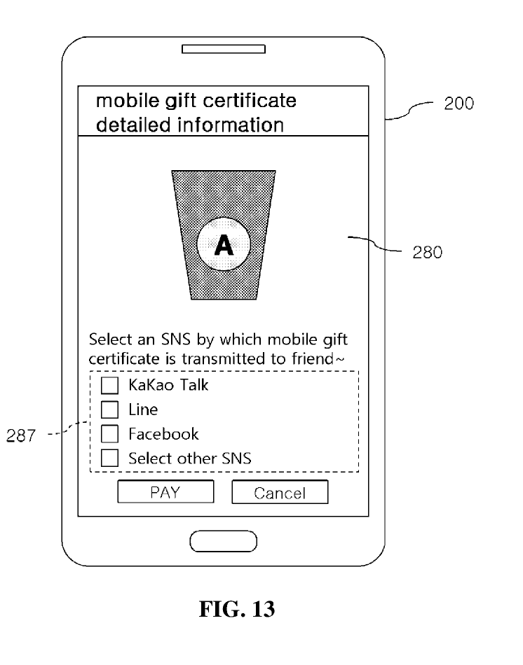

Referring to FIG. 13, information on the plurality of social network services (SNS) selectable by the user may be displayed on the screen of the terminal device 200 to have the SNS to be used in transmission of the mobile gift certificate transmit be selected.

Accordingly, the user may verify information 287 on the plurality of SNSs and then may select any one SNS among them, by which may have the mobile gift certificate be transmitted to the other user through the corresponding SNS.

On the other hand, the plurality of SNSs may be selected and arranged on the screen based on the market share of social network service at the first country where the user of the terminal device 200 is located or at the second country where the other user is located.

For example, as shown in FIG. 13, according to the SNS market share at ‘Korea’ where the user of the terminal device 200 is located, SNSs selectable by the user may be displayed on the screen in order of ‘KaKao Talk’, ‘Line’, ‘Facebook’ starting from the one have the highest market share.

And, the mobile gift certificate management server 300 may perform an automatic translation process to have information on the mobile gift certificate list be displayed on the terminal device 200 in the language of the first country where the user of the terminal device 200 is located.

That is, as shown in FIG. 11 to FIG. 13, even in case that information on the corresponding mobile gift certificate is prepared in a language (for example, ‘English’) of the corresponding country as the location is overseas where the mobile gift certificate is usable, the mobile gift certificate management server 300 may translate automatically and provide a variety of information on the mobile gift certificate list to ‘Korean’ which is the language of the country where the user of the terminal device 200 is located.

And, the user may input the message wanted to be delivered in a language of the first country (for example, ‘Korean’) where the user is located using a message input window 285 shown in FIG. 12 together with mobile gift certificate to the other user.

After then, the terminal device 200 may transmit information on the mobile gift certificate selected by the user to the SNS server 110 (S513), and the SNS server 110 may transmit the mobile gift certificate information received from the terminal device 200 to the mobile gift certificate management server 300 (S514).

The mobile gift certificate management server 300 receiving the mobile gift certificate information selected by the user may perform a process for purchase and payment of the mobile gift certificate, and then may transmit the corresponding mobile gift certificate to the other user's terminal device (S515).

When the user may pay a certain mobile gift certificate included in the mobile gift certificate list in the currency of the first country where oneself is located, the mobile gift certificate management server 300 may deposit a sum of second country currency corresponding to the paid sum of first country currency to process a credit account.

For example, when the payment process for ‘\4,400’ which is the KRW price of the corresponding product is completed by selecting Tay' on the screen as shown in FIG. 13, ‘$4.00’ of USD corresponding to ‘\4,400’ of KRW price may be deposited, by which a credit account may be processed.

When the user may complete the payment on the mobile gift certificate as described above, the mobile gift certificate management server 300 may process an automatic translation to have information on the corresponding mobile gift certificate and message inputted by the user be displayed in a language of the second country where the other user is located, to transmit the corresponding mobile gift certificate to the other user's terminal device together with related information.

For example, the mobile gift certificate information and the message inputted by the user displayed in ‘Korean’ as shown in FIG. 12 may translated automatically into ‘English’ which is the language of the country where the other user is located to be transmitted to the other user's terminal device.

On the other hand, the language displayed or inputted on the user's terminal device 200 or the other user's terminal device as described above may be changeable according to the user's selection.

And, in case that the other user may use the mobile gift certificate received as present from the user, the mobile gift certificate management server 300 may remit the sum of second country currency deposited in relation to the corresponding mobile gift certificate to process as sales.

More specifically, at the time of other user's usage of the mobile gift certificate, the mobile gift certificate management server 300 may transmit information such as used shop, name of merchandise, corresponding PIN, price of merchandise and tax breakdown and the like to the server of the corresponding affiliate member together with remit process and may perform automatically an accounting process on an overseas payment fees and for related entities.

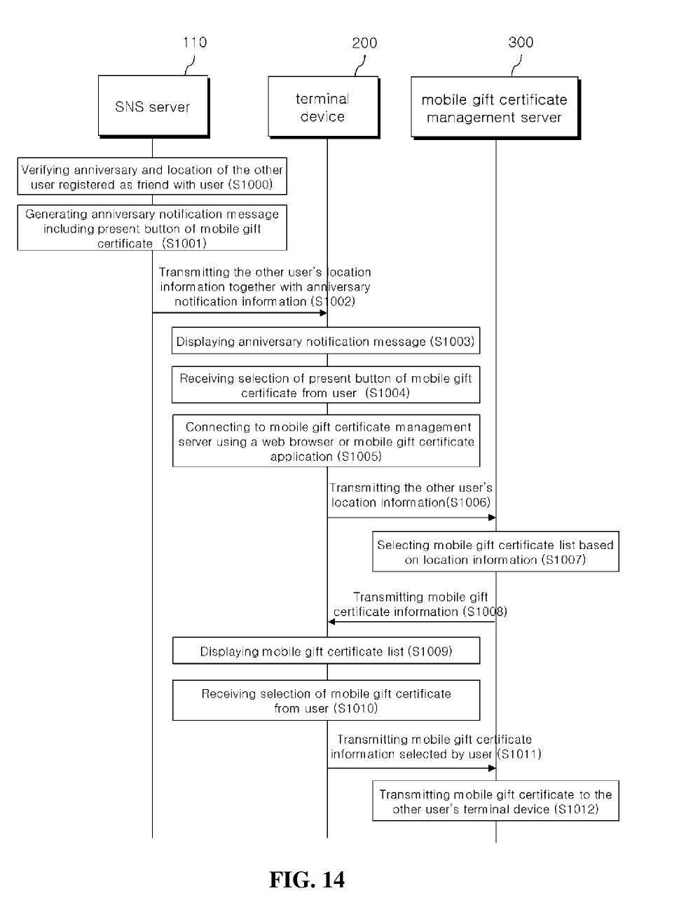

FIG. 14 shows a second embodiment on the method for providing mobile gift certificate service at a system for providing mobile gift certificate service as a timing diagram, and the description on the same thing in the method shown in FIG. 14 as that described in reference to FIG. 1 to FIG. 13 may be omitted.

Referring to FIG. 14, the SNS server 110 may verify the other user's anniversary and location registered as friend to the user of the terminal device 200 (S1000), may generate the anniversary notification message including the present button of mobile gift certificate (S1001), and may transmit the other user's location information to the terminal device 200 together with the anniversary notification information including the generated anniversary notification message (S1002).

The terminal device 200 may display the anniversary notification message notifying the other user's anniversary registered as friend on the screen using the anniversary notification information transmitted from the SNS server 110 (S1003).

When the present button of mobile gift certificate displayed together with the anniversary notification message is selected by the user of the terminal device 200 (S1004), the terminal device 200 may connect to the mobile gift certificate management server 300 using a web browser or mobile gift certificate application (S1005).

For example, when the user may press the present button of mobile gift certificate displayed together with anniversary notification message, the terminal device 200 may implement a web browser, and then may connect to the mobile gift certificate management server 300 using URL provided from the application server 100.

As another method for connecting to the mobile gift certificate management server 300, when the present button of mobile gift certificate is pressed, the terminal device 200 may implement the mobile gift certificate application in linkage to the mobile gift certificate management server 300 to connect to the mobile gift certificate management server 300.

The terminal device 200 may transmit the other user's location information to the mobile gift certificate management server 300 to request the mobile gift certificate information including the mobile gift certificate list targeted based on location (S1006).

In response to the request, the mobile gift certificate management server 300 may select the list of the mobile gift certificates based on the other user's location information (S1007) and may transmit the mobile gift certificate information including the selected mobile gift certificate list to the terminal device 200 (S1008).

The terminal device 200 may display the mobile gift certificate list selectable by the user on the screen using the mobile gift certificate information received from the mobile gift certificate management server 300 (S1009) and may receive from the user the selection of mobile gift certificate to be presented to the other user among the displayed mobile gift certificate list (S1010).

And then, the terminal device 200 may transmit information on the mobile gift certificate selected by the user to the mobile gift certificate management server 300 (S1011), and the mobile gift certificate management server 300 may perform a pross for purchase and payment of the mobile gift certificate, and then may transmit the corresponding mobile gift certificate to the other user's terminal device (S1012).

Though an embodiment of the present invention has been described above with an example that the anniversary notification message including the present button of mobile gift certificate is displayed through an SNS application, the mobile gift certificate service according to the present invention may be provided through a variety of applications having the function of transmitting the anniversary notification message except for the SNS application.

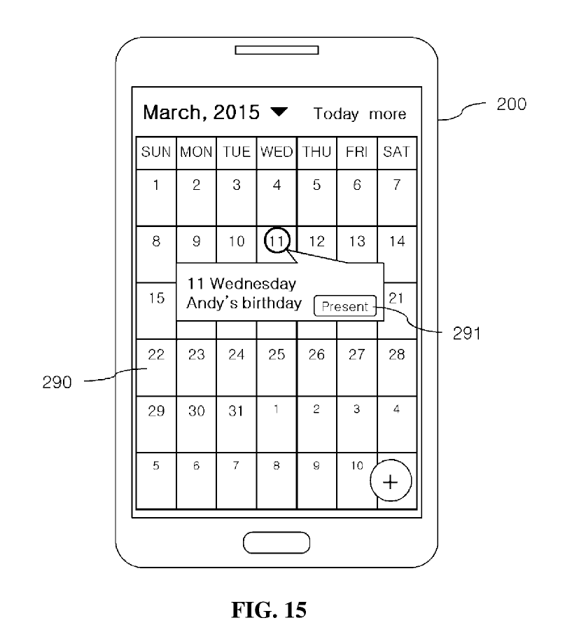

Referring to FIG. 15, a schedule management application is implemented on the terminal device 200, and present button of mobile gift certificate 291 may be included in the anniversary notification message notifying birthday of the other user (ANDY) registered to the schedule management application.

The method for providing mobile gift certificate service according to the present invention described above may be produced as a program for implemented on a computer and may be saved in a recording medium which the computer can read, and the examples of the recording medium which the computer can read may include ROM, RAM, CD-ROM, magnetic tape, floppy disk, light data storage device and the like, and further include ones realized in the form of carrier wave (for example a transmission through the internet).

The recording medium which the computer can read may be distributed over a computer system connected by a network, and the code which the computer can read may be saved and implemented in a distributed way. And, a functional program, a code and code segments for implementing the method may be inferred easily by programmers of technical field where the present invention pertains.

And, even though a desirable embodiment of the present invention has been illustrated and described above, the present invention may not be limited to the specific embodiment described above, but, of course, can allow a variety of changed implementation by a person having an ordinary understanding in the technical field where the present invention pertains without escaping from the gist of the present invention claimed in the claim, and these changed implementations should not be understood as to be separated from the technical idea or perspective of the present invention.

1. A method for providing mobile gift certificate service at a server which can communicate with a terminal device, comprising
acquiring other user's anniversary information and location information who being related to a user;
transmitting an anniversary notification information to the user's terminal device to have an anniversary notification message be displayed on the terminal device including GUI (Graphic User Interface) for presenting the mobile gift certificate to the other user using the acquired other user's anniversary information; and
transmitting a mobile gift certificate information to the terminal device in case that the GUI included in the anniversary notification message is selected to have a mobile gift certificate list selected based on the other user's location information be displayed on the terminal device.

2. A method for providing mobile gift certificate service at a server which can communicate with a terminal device, comprising
acquiring other user's location information to whom a mobile gift certificate being presented;
organizing a mobile gift certificate list including one or more mobile gift certificates usable at affiliate members adjacent to the other user's location based on the acquired other user's location information;
acquiring an exchange rate information between a first country and a second country in case that the first country where the user of the terminal device being located and the second country where the other user being located are different each other;
converting a price calculated in a currency of the second country to that of the first country with respect to the mobile gift certificate included in the mobile gift certificate list based on the acquired exchange rate information; and
processing for the organized mobile gift certificate list to be transmitted to the terminal device together with information on the price of the mobile gift certificate converted in the currency of the first country.

3. The method for providing mobile gift certificate service according to claim 2, wherein
an anniversary notification message including a GUI (Graphic User Interface) for presenting the mobile gift certificate to the other user being displayed on the user's terminal device using the other user's anniversary information.

4. The method for providing mobile gift certificate service according to claim 3, wherein
the other user's anniversary information or location information being acquired in linkage to at least one application of contact, schedule management and social network service (SNS) which the user or other user using.

5. The method for providing mobile gift certificate service according to claim 2, further comprising
processing information on the mobile gift certificate list to be displayed on the terminal device in a language of the first country.

6. The method for providing mobile gift certificate service according to claim 2, further comprising
processing the mobile gift certificate selected by the user among the mobile gift certificate list to be transmitted to the other user's terminal device.

7. The method for providing mobile gift certificate service according to claim 6, wherein
the mobile gift certificate being transmitted to the other user's terminal device using the social network service selected by the user among the plurality of social network services.

8. The method for providing mobile gift certificate service according to claim 7, wherein
the plurality of social network services being arranged based on market share of social network service in at least one of the first country and the second country.

9. The method for providing mobile gift certificate service according to claim 6, further comprising
processing information on the selected mobile gift certificate to be displayed on the other user's terminal device in a language of the second country.

10. The method for providing mobile gift certificate service according to claim 2, further comprising
processing in credit account in case that the user pays any one mobile gift certificate among the mobile gift certificate list in a currency of the first country by depositing sum of second country currency corresponding to the paid sum of first country currency.

11. The method for providing mobile gift certificate service according to claim 10, further comprising
processing in sales in case that the other user using the mobile gift certificate by remitting the deposited sum of second country currency.

12. The method for providing mobile gift certificate service according to claim 2, wherein
the price information on the mobile gift certificate including two or more different prices one another on the same merchandise according to the other user's location.

13. The method for providing mobile gift certificate service according to claim 2, further comprising
grouping plurality of affiliate members of the same price and tax on the same merchandise as one group usable the mobile gift certificate based on merchandise price and tax by region in the second country.

14. A recording medium in which a program being recorded for implementing a method of claim 1 on a computer.

15. A server device performing a method of claim 1.

16. A system for providing mobile gift certificate service, comprising
a terminal device receiving selection of the other user to whom the mobile gift certificate being presented from a user; and
a mobile gift certificate management server for organizing a mobile gift certificate list including one or more mobile gift certificates usable at affiliate members adjacent to the other user's location based on the other user's location information, for acquiring an exchange rate information between a first country and a second country in case that the first country where the user of the terminal device being located and the second country where the other user being located are different each other, and for converting to provide a price calculated in a currency of the second country to that of the first country with respect to the mobile gift certificate included in the mobile gift certificate list based on the acquired exchange rate information.

17. The system for providing mobile gift certificate service according to claim 16, further comprising
an application server transmitting an anniversary notification information to the terminal device for an anniversary notification message including a GUI for presenting the mobile gift certificate to the other user to be displayed on the user's terminal device.

18. A recording medium in which a program being recorded for implementing a method of claim 2 on a computer.

19. A server device performing a method of claim 2.
